(19) United States
(12) Patent Application Publication
(10) Pub. No.: US 2009/0071305 A1
(43) Pub. Date: Mar. 19, 2009

(54) PROGRAMMABLE BORDER SLITTER

(75) Inventors: Terrance L. Myers, Carl Junction, MO (US); Jeff Kaetterhenry, Davie, FL (US); Ivan Habek, Ivanec (HR); Stjepan Vadlja, Cakovec (HR)

Correspondence Address: WOOD, HERRON & EVANS, LLP, 2700 CAREW TOWER, 441 VINE STREET, CINCINNATI, OH, 45202, US

(73) Assignee: L&P PROPERTY MANAGEMENT COMPANY, South Gate, CA (US)

(21) Appl. No.: 12/209,441

(22) Filed: Sep. 12, 2008

Related U.S. Application Data
(60) Provisional application No. 60/990,457, filed on Nov. 27, 2007.
(60) Provisional application No. 60/972,466, filed on Sep. 14, 2007.

(51) Int. Cl. B26D 1/143; B26D 7/26; B26D 7/12

(52) U.S. Cl. 83/156; 83/174; 83/331; 83/425.4; 83/481; 83/508.3

(57) ABSTRACT

An apparatus for feeding and slitting soft goods has multiple slitting systems with respective slitting blades mounted on a cross rail. A slitting blade positioning system is movable parallel with the cross rail and operable to move slitting systems along the cross rail. A material feed motor is connected to a feed roller and operable to move the soft goods past the slitting system. A control is first operable to cause the slitting blade positioning system to successively move slitting systems to desired positions on the cross rail. Thereafter, the control operates a slitting blade motor to rotate slitting blades and the material feed motor, thereby moving the soft goods past the slitting blades.

### CROSS REFERENCE TO RELATED APPLICATIONS

This application claims the benefit of the filing date of U.S. Provisional Patent Application Ser. No. 60/990,457, which is fully incorporated herein. This application further claims the benefit of the filing date of U.S. Provisional Patent Application Ser. No. 60/972,466, which is fully incorporated herein.

### FIELD

This invention relates generally to cutting flat soft goods and more particularly, to feeding and slitting a wide piece of material. The invention is particularly useful for slitting border pieces forming edges of mattress covers and other quilted soft goods.

### BACKGROUND

In the manufacture of bedding, a mattress cover is often comprised of upper and lower panels that are often fabricated from layers of different soft goods. Such mattress cover panels are typically made on wide-width multi-needle quilting machines and associated panel cutters such as those described in U.S. Pat. Nos. 5,154,130, 5,544,599 and 6,237,517, all hereby expressly incorporated by reference herein. The upper and lower panels are separated by a border piece that forms the sides of a mattress and extends around the full perimeter of the panels. Multiple mattress border pieces are often cut from a single, wide piece of fabric on a border slitting machine having multiple slitting blades in parallel across a width of the slitting machine.

One or more manual operations are required with known border slitting machines. For example, prior to slitting border pieces, the slitting blades must be manually positioned at desired locations. The positioning operation requires that the slitting blades be unlocked, for example, by loosening a locking screw, manually moved to new positions across the width of the slitting machine and then, manually locked at the new positions. Further, the slitting blades may require manual sharpening. In addition, after the border pieces are slit, the border pieces may then be manually cut to a desired length. The above manual operations are labor intensive, relatively slow and time consuming, which substantially increases costs associated with the manufacture of the border pieces.

Further, with known border slitting machines, the slitting blades are mounted on a common drive shaft that extends across the width of the slitting machine. Thus, replacement of a slitting blade requires the removal of all of the slitting blades that are closer to an end of the support shaft. Again, the required removal of multiple slitting blades to replace a single slitting blade is labor intensive, time consuming and requires the slitting machine be out of production. Thus, replacing a slitting blade reduces the efficiency of the slitting operation and substantially adds to its cost.

Therefore, there is a need for an improved border slitting machine that is more automated and efficient.

### SUMMARY

The present invention provides a programmable border slitter that is fully automated and eliminates known manual operations. The programmable border slitter automatically positions and sharpens the slitting blades; and further, slit border pieces are automatically cut to length. In addition, the slitting blades are individually mounted and thus, replaceable without having to remove other slitting blades. Thus, the programmable border slitter may be operated continuously, is very efficient and border pieces can be manufactured in substantially less time.

According to certain embodiments, an apparatus for feeding and slitting soft goods has multiple rollers including feed and pinch rollers that carry the soft goods. A cross rail is generally parallel to but spaced from the rollers; and multiple slitting systems with respective slitting blades are mounted on the cross rail. A slitting blade motor is operably connected to a slitting blade. A slitting blade positioning system is movable parallel with the cross rail, and the slitting blade positioning system is operable to move a slitting system over a substantial length of the cross rail and thus, a substantial width of the soft goods. A material feed motor is connected to the feed roller and operable to move the soft goods past the slitting system. A control is connected to the slitting blade motor, the slitting blade positioning system and the material feed motor, and the control is first operable to cause the slitting blade positioning system to move the slitting system to a desired position on the cross rail. The control is further operable to turn on the slitting blade motor and the material feed motor, thereby moving the soft goods past the slitting blade.

According to another aspect, the slitting blade positioning system may have a carriage mounted parallel to the cross rail; and the control causes the carriage to move a slitting system to a desired position on the cross rail. In an alternative embodiment, the slitting blade positioning system may have positioning motors mounted on respective slitting systems; and the positioning motors are operable by the control to independently move the respective slitting systems to desired positions along the cross rail.

In a further aspect, the slitting blades are rotated by a common blade drive motor; and in an alternative embodiment, each slitting system has a blade drive motor connected to a respective slitting blade. In yet other aspects, a blade sharpener is mounted adjacent the slitting systems; and the slitting blade positioning system is used to move a slitting system adjacent the blade sharpener to sharpen a slitting blade. In an alternative embodiment, a blade sharpener is mounted on each slitting system and operable by the control to sharpen a respective slitting blade. In a further embodiment, a blade sharpener is mounted on a drive system to be moved parallel to the cross rail; the blade sharpener is movable by the control to a position adjacent a slitting blade to be sharpened.

In a still further aspect, a cross cutter system is connected to the control for cutting slit soft goods to a desired length.

These and other objects and advantages of the present invention will become more readily apparent during the following detailed description taken in conjunction with the drawings herein.

### BRIEF DESCRIPTION OF THE DRAWINGS

FIG. 1 is an upstream end view of a programmable border slitter.

FIG. 2 is a cross-sectional side view of the programmable border slitter of FIG. 1.

FIG. 3 is a perspective view of the front end of the programmable border slitter of FIG. 1.

FIG. 4 is a partial perspective view of the front end of the programmable border slitter of FIG. 1.

FIG. 5 is a perspective view of one side of an exemplary first slitting blade system usable with the programmable border slitter of FIG. 1.

FIG. 6 is an elevation of an opposite side of the first slitting blade system.

FIG. 7 is a cross-sectional view of the first slitting blade system, positioning carriage and support bar assembly of the programmable border slitter of FIG. 1.

FIG. 8 is a perspective view of an exemplary embodiment of a positioning carriage usable with the programmable border slitter of FIG. 1.

FIG. 9 is a cross-sectional view of the first slitting blade system, positioning carriage and support bar assembly of the programmable border slitter of FIG. 1.

FIG. 10 is a perspective view of an exemplary embodiment of a material feed used with programmable border slitter of FIG. 1.

FIG. 11 is a cross-sectional side view of the programmable border slitter of FIG. 1.

FIG. 12 is an end view of a cross cutter system.

FIG. 13 is a schematic block diagram of a control circuit of the programmable border slitter of FIG. 1.

FIG. 14 is a flowchart schematically illustrating a slitting blade positioning process executable by the programmable border slitter of FIG. 1.

FIG. 15 is a flowchart schematically illustrating a material slitting process executable by the programmable border slitter of FIG. 1.

FIG. 16 is a partial perspective view of the front end of a programmable border slitter and illustrates alternative embodiments of a slitting system positioning system and slitting blade drive motors.

FIG. 17 is a partial perspective view of the front end of a programmable border slitter and illustrates a first alternative embodiment of a slitting blade sharpen system.

FIG. 18 is a partial perspective view of the front end of a programmable border slitter and illustrates a second alternative embodiment of a slitting blade sharpen system.

FIG. 19 is a perspective view of an exemplary alternative embodiment of a second slitting system usable with a programmable border slitter similar to that shown in FIG. 1.

FIG. 20 is a perspective view of one end of the second slitting system shown in FIG. 19.

FIG. 21 is a perspective view of an exemplary alternative embodiment of a second slitting blade assembly used with the second slitting system shown in FIG. 19.

FIG. 22 is a partial cross-sectional view taken along line 22-22 in FIG. 21 of the second slitting blade assembly.

FIG. 23 is a perspective view of an exemplary alternative embodiment of a second slitting blade positioner used with the second slitting system of FIG. 19.

FIG. 24 is a perspective view of exemplary alternative embodiment of a third slitting system usable with a programmable border slitter similar to that shown in FIG. 1.

FIG. 25 is a cross-sectional view of the exemplary alternative embodiment third slitting system shown in FIG. 24.

FIGS. 26A is a partial perspective view showing an exemplary embodiment of a split slitting blade mounted on a slitting blade drive shaft.

FIGS. 26B is a partial perspective view showing the split slitting blade of FIG. 26A removable from the slitting blade drive shaft.

### DETAILED DESCRIPTION

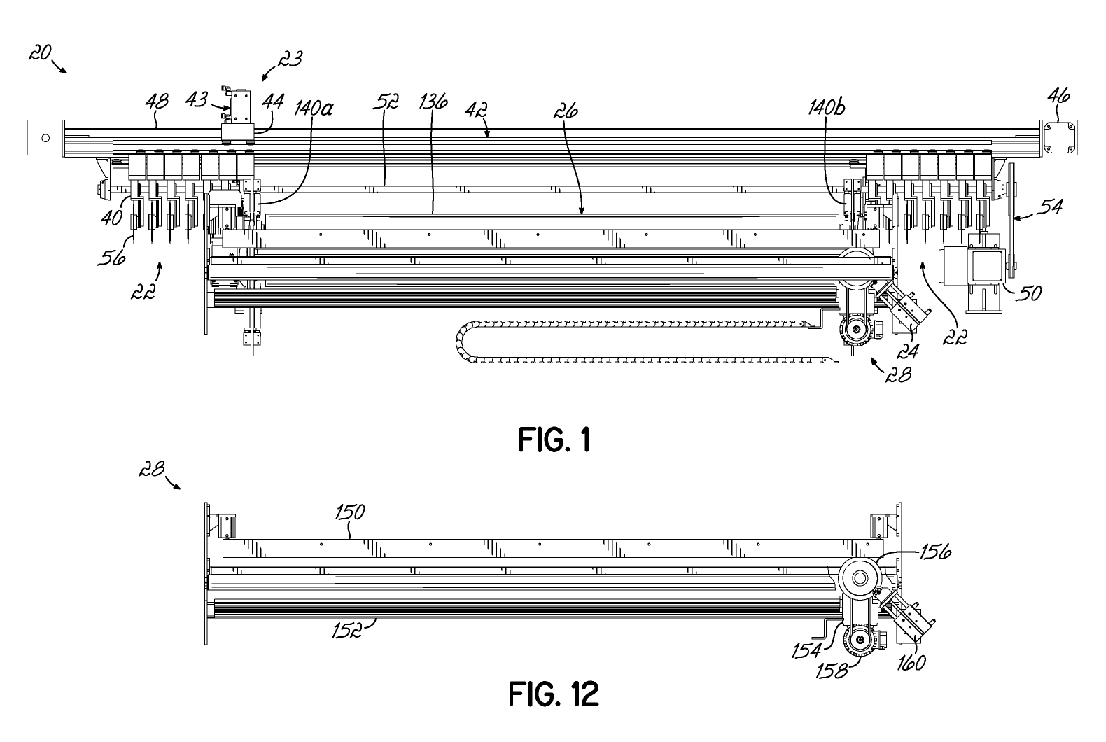

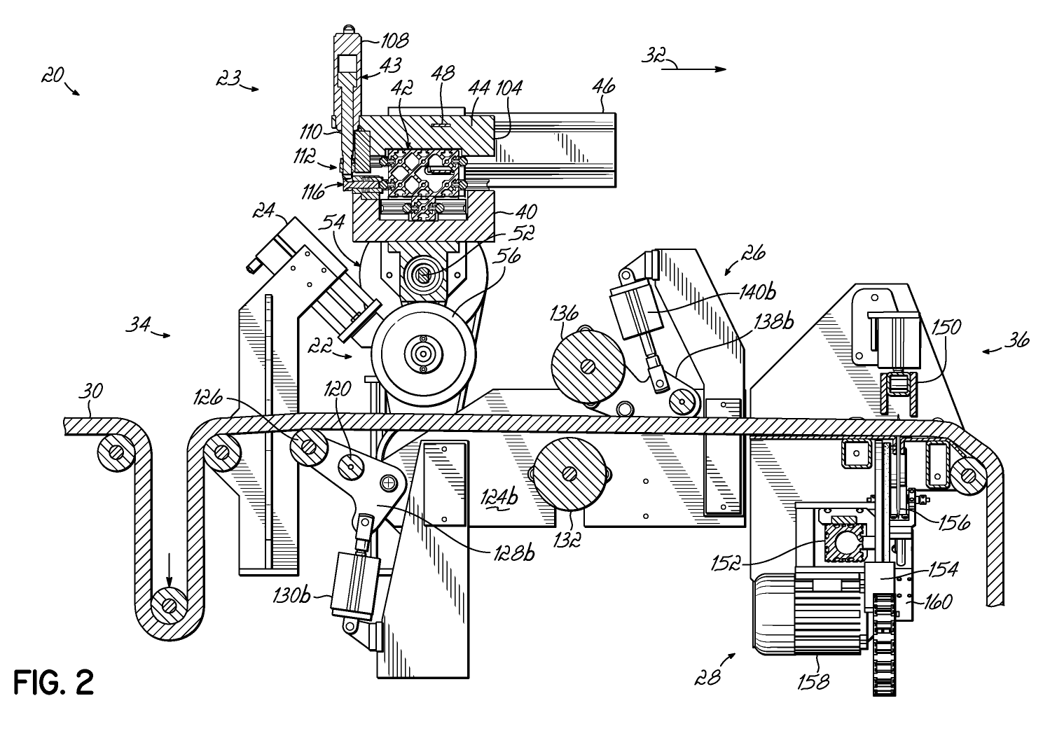

Referring to FIGS. 1 and 2, an exemplary embodiment of a programmable border slitter 20 includes exemplary embodiments of a slitting system 22, a slitting blade positioning system 23, a slitting blade sharpener system 24, a material feed system 26 and a cross cutter system 28. Material 30 to be slit is fed through the programmable border slitter 20 from left to right as viewed in FIG. 2 and shown by the arrow 32. The material 30 is only a representative showing; and in practice, either single pieces or a stack of soft goods may be cut. A downstream direction means a direction the same as the direction of material flow arrow 32, and an upstream direction mean a direction opposite the direction of material flow arrow 32. Further, the border slitter 20 has a front 34 into which the material 30 is fed and a back 36 from which the material 30 exits the border slitter 20. Thus, FIG. 1 is an end view of the border slitter 20 looking from the back toward the front in an upstream direction. Depending on the application, the border slitter 20 may be supported on a base or frame (not shown) in a generally horizontal orientation as shown in FIG. 2 or alternatively, in a generally vertical orientation.

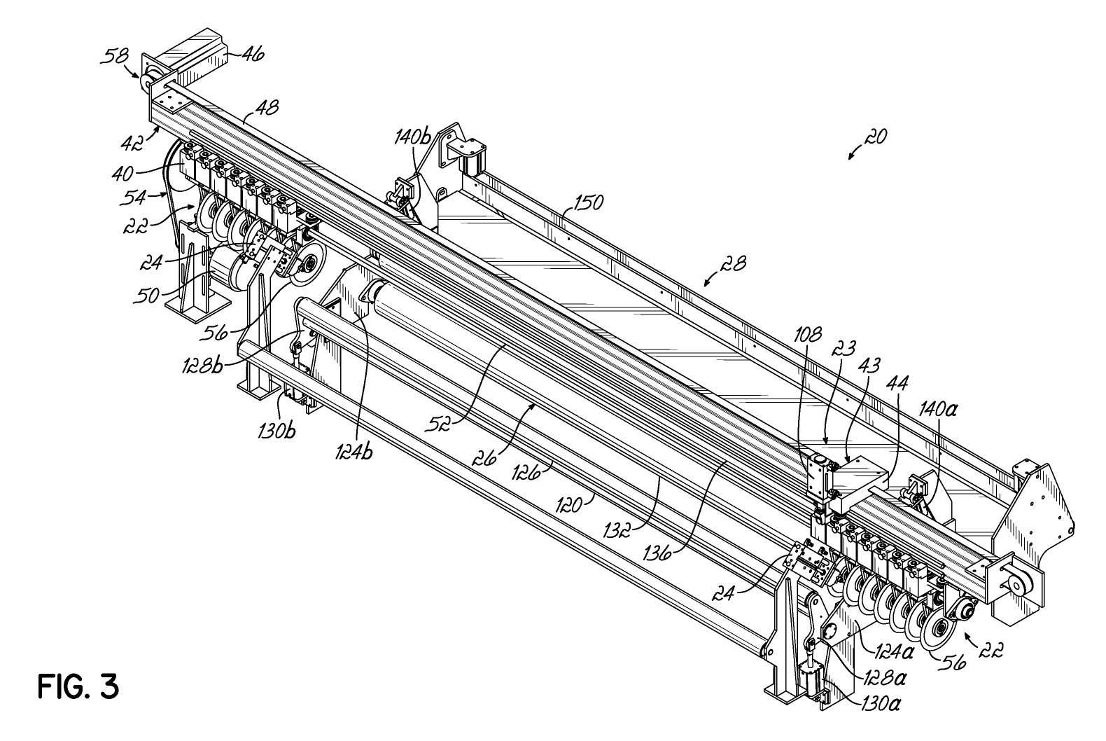

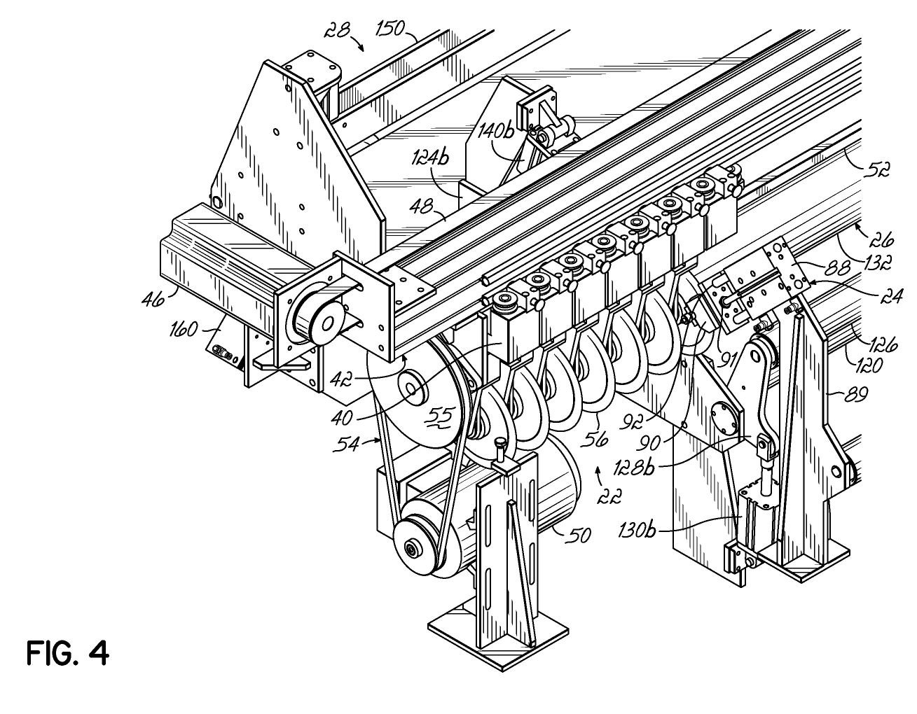

Referring to FIG. 3, the slitting system 22 includes a plurality of slitting blade assemblies 40 that are moveably mounted on a support bar assembly 42 that extends across a width of the border slitter 20. The slitting blade positioning system 23 has a slitting blade positioner 43 that includes positioning carriage 44, which is also mounted on the support bar assembly 42. The positioning carriage 44 is connectable to a drive belt 48 that is part of a belt and pulley drive 58 operated by a drive motor 46, which is operable to move the positioning carriage 44 to different positions on the support bar assembly 42. Thus, the support bar assembly 42 functions as a cross rail or track for the slitting blade assemblies 40 and the slitting blade positioning carriage 44. As shown in FIG. 4, a slitting blade drive motor 50 rotates a slitting blade drive pulley 55 and drive shaft 52 by means of a pulley and belt drive 54. In this embodiment, all of the slitting blades 56 are rotated by a common drive shaft 52.

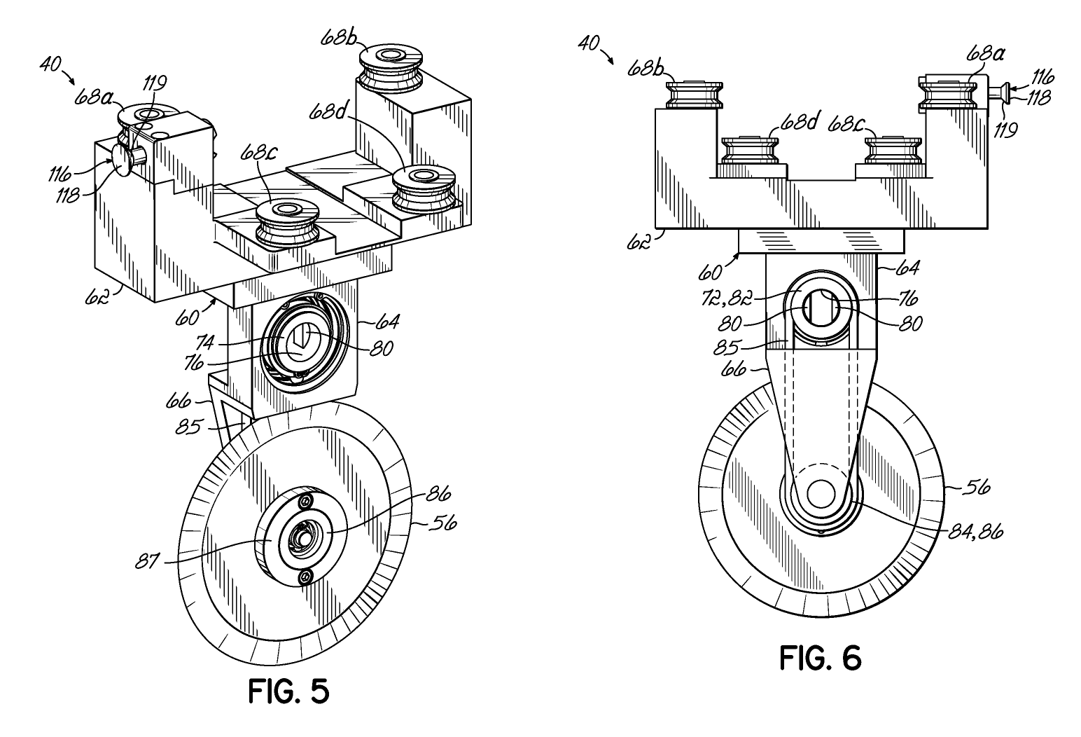

Each of the slitting blade assemblies 40 is substantively identical; and therefore, only a single system will be shown and described in detail. Referring to FIG. 5, each slitting blade system 40 has a mounting bracket 60 that includes a guide block 62, a drive block 64 and a slitting blade mount 66. Guide rollers 68a-68d are mounted on the guide block 62, and the guide rollers 68a-68d freely rotatable with respect to the slitting blade system 40.

The drive block 64 has a drive collar 74 that is mounted in bearings and thus, freely rotatable with respect to the drive block 64. The central bore 76 has opposed keys 80. The keys 80 are separated by a distance permitting the drive shaft 52 (FIG. 4) to slide therebetween. The drive shaft 52 has a noncircular cross section, for example, a square, hexagonal, octagonal or other noncircular cross section; and thus, the drive collar 74 is rotated by the drive shaft 52. Referring to FIG. 6, a drive pulley 82 is rigidly connected to one end of the drive collar 74. The drive pulley provides rotational motion to a driven pulley 84 by means of a belt 85. The driven pulley 84 is mounted on one end of a spindle 86 (FIG. 5), and the spindle 86 and driven pulley 84 are freely rotatable with respect to the slitting blade mount 66. The slitting blade 56 is mounted on an opposite end of the spindle 86 and is held in place by a nut 87 that is threaded onto the opposite end of the spindle 86. Thus, the slitting blade 56 may be easily replaced by simply removing the nut 87.

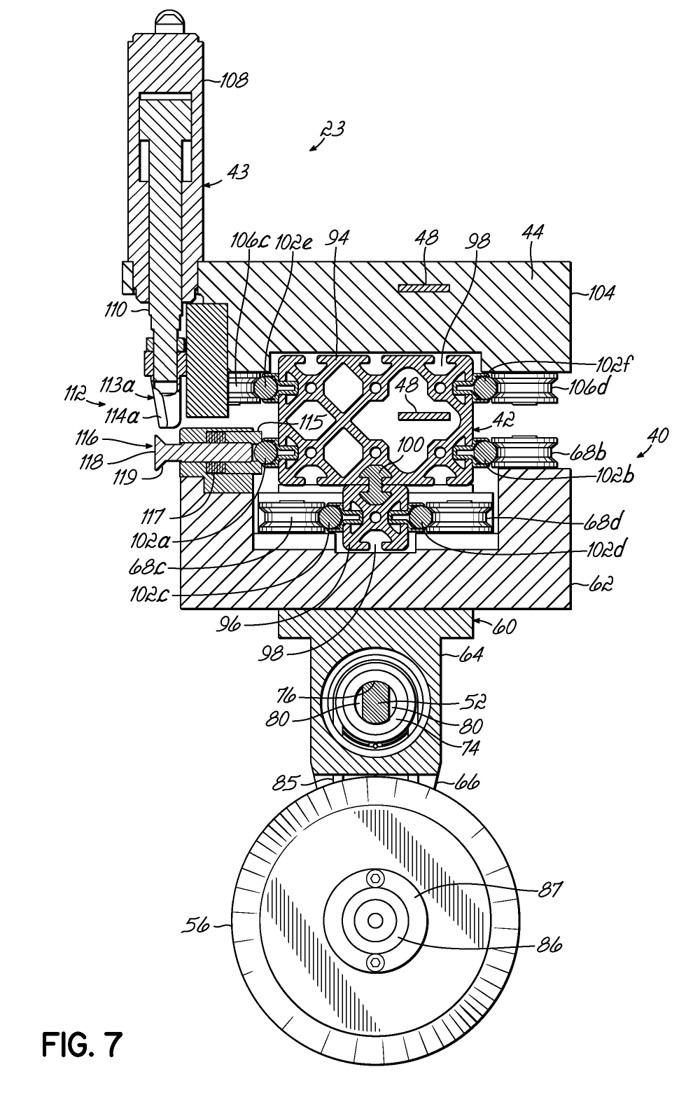

Referring to FIG. 7, the support bar assembly 42 is made up of a large support bar 94 and a small support bar 96. The support bars 94, 96 are commercially available aluminum extrusions. The support bars 94, 96 have a plurality of lengthwise T-slots 98 located about a cross-sectional perimeter, and the support bars are connected together by fasteners, one of which is shown at 100, which are also commercially available for that purpose. A plurality of linear guide rails 102a-102f are inserted in selected T-slots 98 and held in place by a friction fit. The guide rails 102a-102f are also commercially available parts that are designed to be used with the support bars 94, 96. A slitting blade system 40 is mounted on the support bar assembly 42 by sliding the guide rollers 68a-68d over respective guide rails 102a-102d, thereby allowing the slitting blade system 40 to be easily moved lengthwise along the support bar assembly 42. As shown in FIG. 1, the support bar assembly 42 has a length that permits slitting blade assemblies 40 not being used to be stored at one or both ends of the support bar assembly 42 in idle positions. Referring to FIG. 6, guide rollers 68a, 68b have a wider separation than guide rollers 68c, 68d to minimize any tendency of the slitting blade system 40 to rock or bind when mounted on the support bar assembly as shown in FIG. 7.

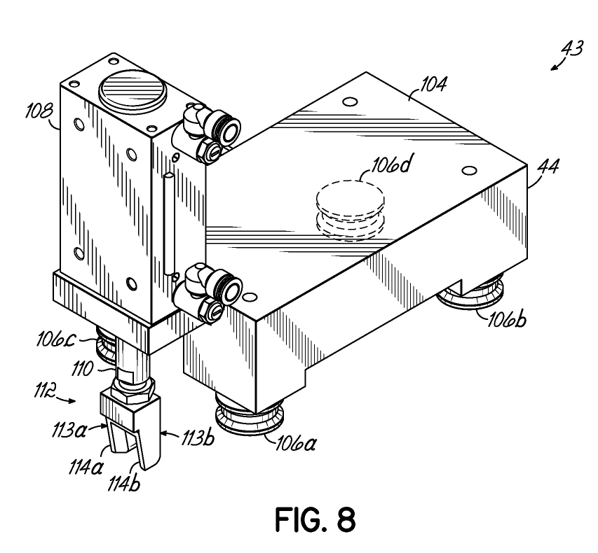

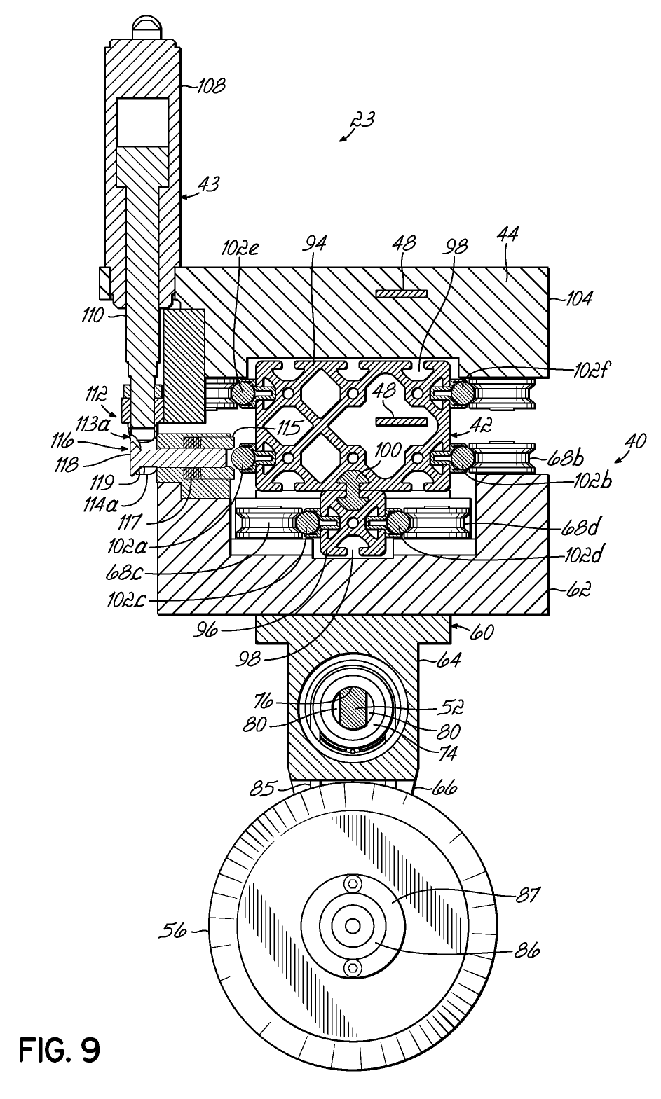

Referring to FIG. 8, the positioning carriage 44 of the slitting blade positioner 43 has a body 104 on which are rotatably mounted four roller guides 106a, 106b, 106c, 106d. A slitting blade pickup cylinder or solenoid 108, which may be pneumatic or electric, is connected at one end of the body 104. The cylinder 108 is operable to extend and retract a cylinder rod 110. A generally U-shaped claw 112 is connected to a distal end of the cylinder rod 110. The claw 112 has opposed legs or fingers 113a, 113b with respective forward edges 114a, 114b that taper toward a distal end of the claw 112.

Referring back to FIG. 7, the positioning carriage 44 is mounted on the support bar assembly 42 by sliding the guide rollers 106a, 106c over linear guide rails 102e and guide rollers 106b, 106d over linear guide rail 102f. Thus, the positioning carriage 42 is freely moveable lengthwise along the support bar assembly 42.

The slitting blade system 40 also has a locking pin 116 that is connected to a collar 115, for example, by threads, pinning or a comparable connection. A biasing device 117, for example, a compression spring, one or more Belleville washers or comparable biasing device, is used to create a biasing force against the collar 115 toward the guide rail 102a. Thus, the biasing means 117 causes the collar 115 and pin 116 to apply a locking force against guide rail 102a, thereby preventing the slitting blade system 40 from moving with respect to the support bar assembly 42. Upon actuating the slitting blade pickup cylinder 108, the cylinder rod 110 and fingers 113a, 113b extend toward the locking pin 116. The tapered forward edges 114a, 114b of the respective fingers 113a, 113b contact the angled surface 119 of the locking pin 116; and upon the cylinder rod 110 and fingers 113a, 113b being fully extended, the claw 112 moves the collar 115 and locking pin 116 to the left as viewed in FIG. 7. Thus, as shown in FIG. 8, the fingers 113a, 113b lift the collar 115 and locking pin 116 from contact with the guide rail 102a. Upon actuation of the positioning motor 46 (FIG. 3), the positioning carriage 44 and slitting blade system 40 are movable lengthwise along the support bar assembly 42. When the positioning carriage 44 has moved the slitting blade system 40 to a desired position, the state of the slitting blade pickup cylinder 108 is switched; and the cylinder rod 110 and fingers 113a, 113b are retracted to the positions shown in FIG. 7. The biasing means 117 moves the collar 115 and locking pin 116 to the right as viewed in FIG. 7 and into contact with the guide rail 102a, thereby preventing the slitting blade system 40 from moving with respect to the guide rail 102a.

As shown in FIG. 3, a blade sharpener system 24 is located at each end of the width of the border slitter 20 adjacent the slitting blades 56. Each sharpener system 24 is substantially similar in construction and operation; and therefore, only one will be described in detail. Referring to FIG. 4, a sharpener cylinder or solenoid 88, which may be pneumatic or electric, is supported on a bracket 89. A slitting blade sharpener 90 is attached to respective distal ends of a cylinder rod 91 and a pair of guide rods 92. In one state, the cylinder 88 retracts the cylinder rod 91, guides rods 92 and sharpener 90, which removes the sharpener 90 from contact with a juxtaposed slitting blade 56. When the state of the cylinder 88 is switched, the cylinder rod 91, guide rods 92 and sharpen 90 are extended to move the sharpener 90 into contact with the juxtaposed slitting blade 56 and sharpening it.

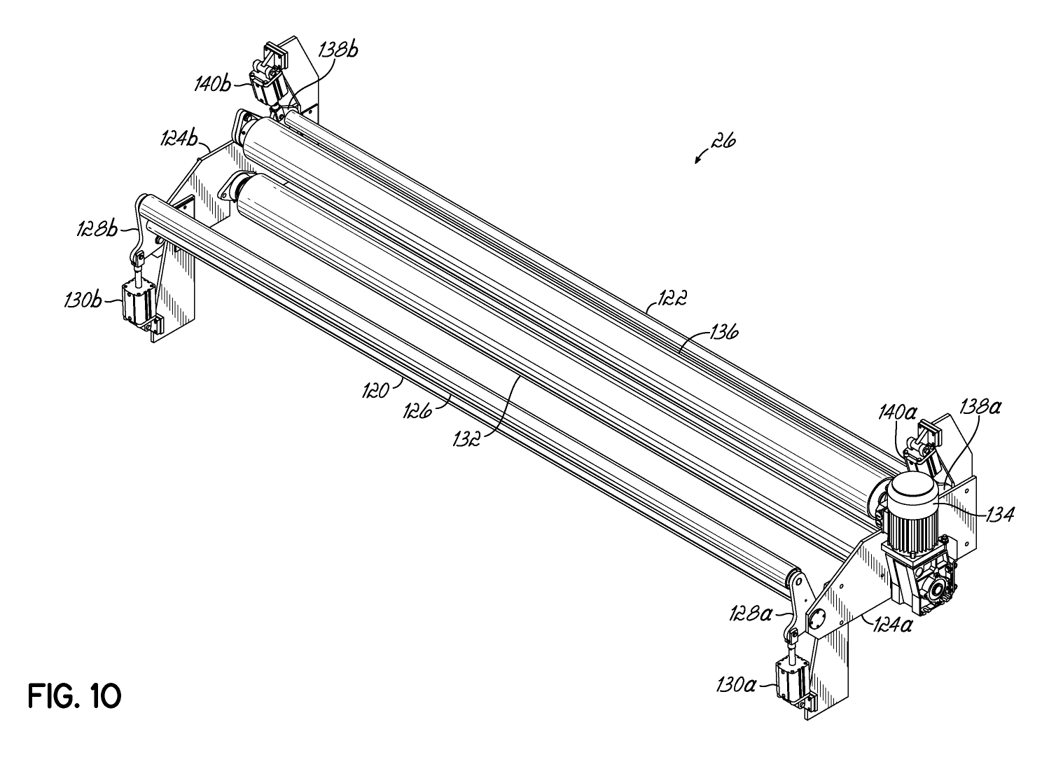

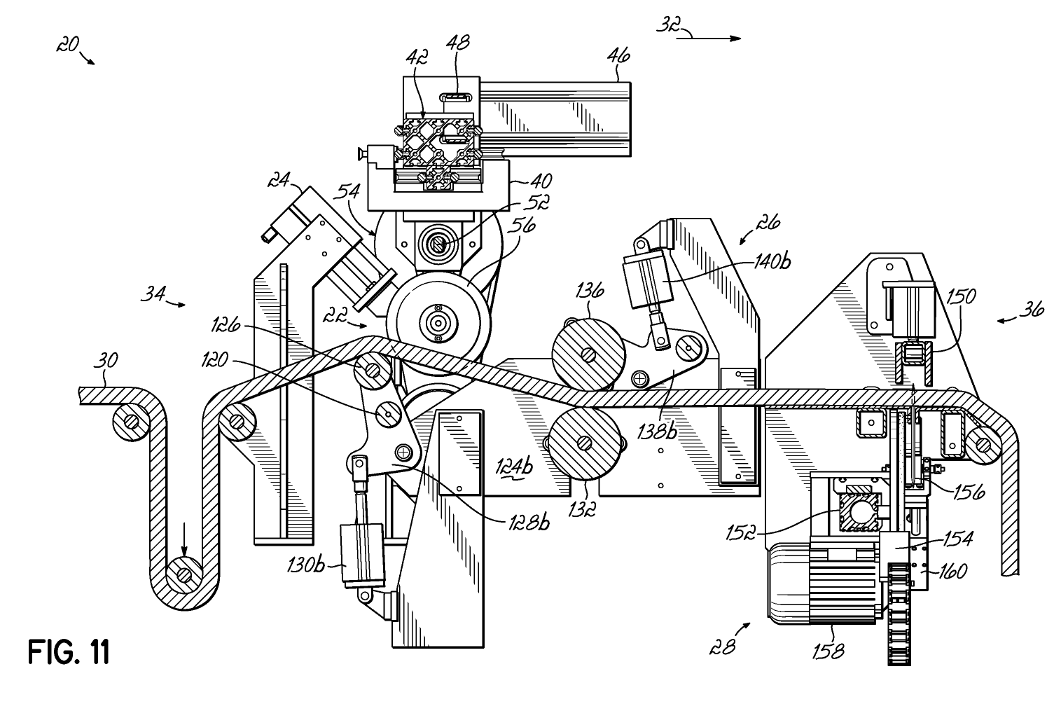

The material feed system 26 is shown in more detail in FIG. 10. The system has two idler rollers 120, 122 that are mounted to be freely rotatable with respect to the idler frame members 124a, 124b A slitting engagement roller 126 is rotatably mounted at its ends to respective ends of angle brackets 128a, 128b that, in turn, are pivotally mounted to respective frame members 124a, 124b. Slitting blade engagement cylinders or solenoids 130a, 130b, which may be pneumatic or electric, are also supported by respective frame members 124a, 124b and are pivotally connected to opposite ends of the respective engagement brackets 128a, 128b. As shown in FIG. 2, when the cylinders 130a, 130b are in a first state, the slitter engagement roller 126 supports the material 30 at a position removed from a slitting blade 56. However, as shown in FIG. 11, when the cylinders 130a, 130b switch states, the slitter engagement roller 126 is pivoted toward the slitting blade 56; and the material 30 is moved to a position engaging the slitting blade 56.

Referring again to FIG. 10, a feed or puller roller 132 is rotated by a material feed motor 134. A pinch roller 136 is rotatably mounted at its ends to respective ends of angle brackets 138a, 138b that, in turn, are pivotally mounted to respective frame members 124a, 124b. Pinch roller cylinders or solenoids 140a, 140b, which may be pneumatic or electric, are also supported by respective frame members 124a, 124b and are pivotally connected to opposite ends of the respective engagement brackets 138a, 138b. As shown in FIG. 2, when the pinch roller cylinders 140a, 140b are in a first state, the pinch roller 136 supports the material 30 at a position removed from puller roller 132; and the material 30 is not pulled through the border slitter 20. However, as shown in FIG. 10, when the pinch roller cylinders 140a, 140b switch states, the pinch roller 126 is pivoted toward and contacts the material 30 supported by the puller roller 132; and the material 30 is pulled through the border slitter 20.

Referring to FIG. 12, the cross cutter system 28 has a frame 150 that extends across a width of the border slitter 20. The frame 150 supports a linear guide rail 152 on which is mounted a cross cutter carriage 154 that, in turn, supports a cross cutter blade 156, a cross cutter motor 158 and a blade sharpener 160. The cross cutter system 28 is operable in a known manner to move the cross cutter blade 156 along the length of the guide rail 152, thereby cutting the material to a desired length. The cross cutter sharpener 160 is substantially similar in construction and operation to the sharpener system 24 described with respect to FIG. 4.

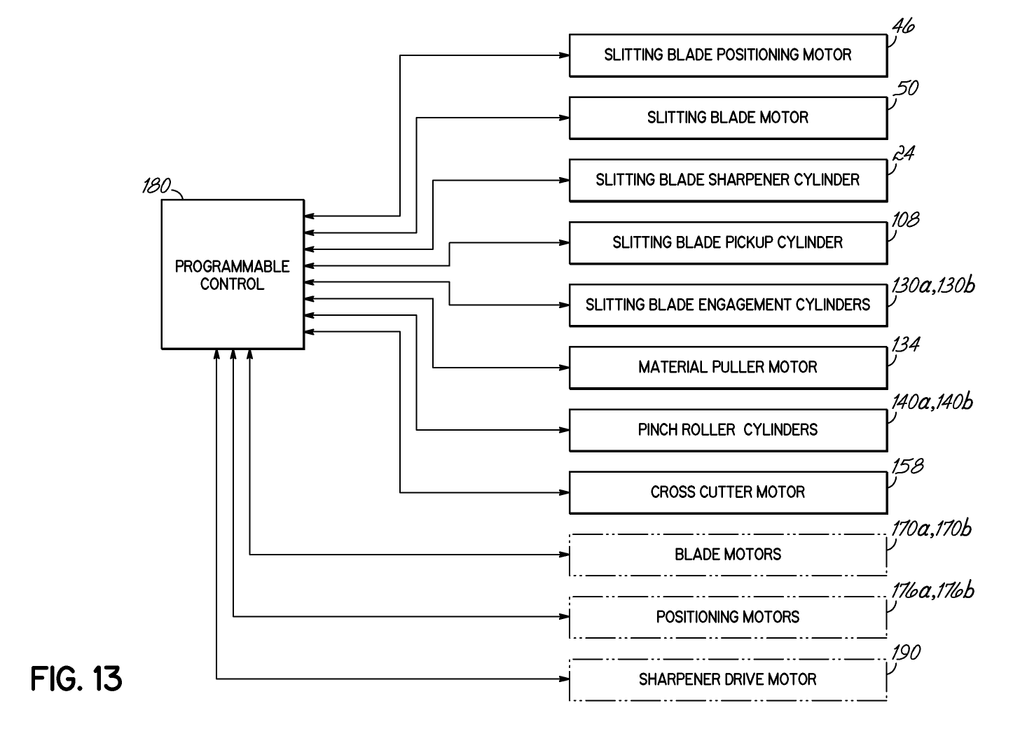

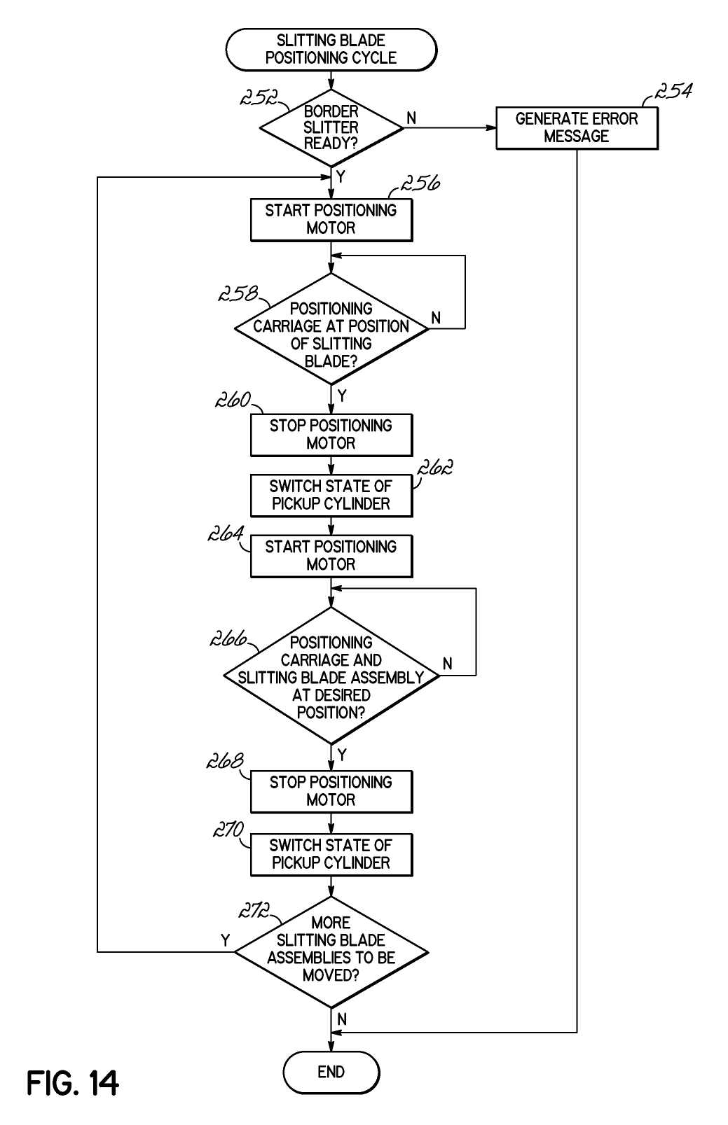

Referring to FIG. 13, a programmable control 180 is used to coordinate the operation of the various motors and cylinders on the programmable border slitter 20. For a particular set of border pieces to be slit, the programmable control 180 contains data relating to the widths of those border pieces; and it operable to move slitting blade assemblies 40 to desired positions on the support bar assembly 42 such that the desired widths of the border pieces will be slit. An exemplary slitting blade positioning cycle is schematically illustrated in FIG. 14. First, at 252, the control 180 determines whether the border slitter is ready to have slitting blade assemblies moved across the support bar assembly 42. For example, the border slitter 20 should have a state as shown in FIG. 2, wherein the slitter engagement roller 126 is retracted from the slitter blades 56. If those conditions or other conditions are not met, the control 180 generates an error message as indicated at 254.

If proper conditions do exist, the control 180, commands, at 256, the positioning motor 46 to move the positioning carriage 44 along the support bar assembly 42 toward a slitting blade system 40 to be picked up. The position of the carriage 44 is detectable by the control 180 using known motor control technologies. Upon the control 180 determining, at 258, that positioning carriage 44 is immediately adjacent a desired slitting blade system, the control 180 then, at 260, stops the positioning motor 46. Thereafter, the control 180 switches, at 262, the state of the pick up cylinder 108. That operation moves the claw 112 below the head of the locking pin 116 and releases the desired slitting blade system for motion along the support bar assembly 42.

Thereafter, the control 180 again, at 264, starts the positioning motor 46 which is effective to move the positioning carriage 44 and the desired slitting blade system 40 along the support bar assembly 42 toward a desired position. When the control 180 detects, at 266, that the desired position is reached, it commands, at 268, the positioning motor 46 to stop. Thereafter, the control 180 commands, at 270, the pick up cylinder 108 to switch states. That operation retracts the claw 116 from beneath the locking pin head 118, thereby permitting the biasing means 117 to move the collar 115 and locking pin 116 against the guide rail 102a, thereby inhibiting motion of the desired slitting blade system with respect to the guide rail 102a. The control 180 then, at 272, determines whether more slitting blade assemblies are to be moved to desired respective positions along the support bar assembly 42. If so, the process described at steps 258-272 is repeated until all of the slitting blade assemblies are in position.

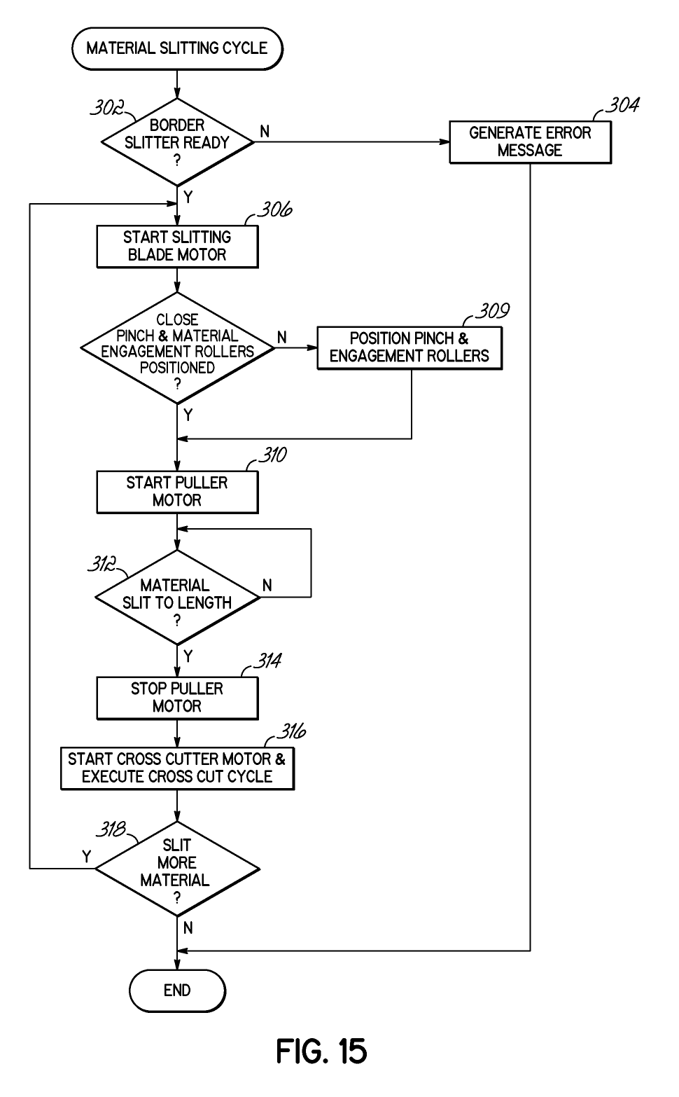

Thereafter, referring to FIG. 15, the control 180 is operative to execute a material slitting cycle. In doing so, the control 180 determines, at 302, whether the border slitter is ready. For example, to be ready, slitting blades must be located in their desired positions; and the material must be loaded. Other conditions may also have to be met. If the border slitter is not ready, an error message is generated at 304. If so, the control 180 commands, at 306, the slitting blade motor 50 to start. In addition, the control determines, at 308, whether the pinch and engagement rollers are in position for slitting the material. If not, the control 180, commands, at 309, the slitter engagement cylinders 130a, 130b and the pinch roller cylinders 140a, 140b to change states. This action causes the material engagement roller 126 to move the material 30 into engagement with the slitting blades 56 and the pinch roller 136 to move against the material 30 on the puller roller 132. With these actions, the border slitter 20 is in the state shown in FIG. 11. The control 180 further commands, at 310, the material feed motor 134 to start. The feed motor 134 pulls the material 30 past the slitting blades 56, thereby slitting the material 30 into border pieces of desired widths. Thereafter, the control determines, at 312, when a desired length of material has been slit. When the length is achieved, the control 180, at 314, stops the material feed motor 134 and, at 316, starts the cross cutter motor and executes a cross cut cycle, thereby cutting the slit border pieces to a desired length. The control 180 then determines, at 318, whether more of the material 30 is to be slit; and if so, the process described with respect to steps 306-318 is repeated.

At any time determined by an operator or timers or cycle counters in the control 180, the control 180 may execute a blade sharpening cycle by first, operating the positioning motor 46 (FIG. 3) to use the positioning carriage 44 to move a desired slitting blade assembly 40 adjacent the sharpener 24. Next, if the drive motor 50 is not running, the control 180 starts the drive motor 50 and switches the state of the sharpener cylinder 88. The sharpener 90 is moved into contact with a respective rotating slitting blade 56 to sharpen the blade. After a period of time that may be determined by a timer in the control 180, the control 180 again switches the state of the sharpener cylinder 88; and the sharpener 90 is retracted from the slitting blade.

The programmable border slitter 20 has the advantages automatically positioning and sharpening the slitting blades 56 and further, automatically slitting the material 30 into border pieces of desired lengths. Further, the programmable border slitter 20 automatically tracks the material 30 during the production process. In addition, the slitting blades 56 are individually mounted and thus, replaceable without having to remove other slitting blades. Thus, the programmable border slitter 20 may be operated continuously, is very efficient and border pieces can be manufactured in substantially less time than with prior methods requiring manual operations.

The programmable border slitter 20 may be incorporated in a production process that uses quilting machines to provide a quilted material prior to slitting, for example, systems that are shown and described in U.S. Pat. Nos. 5,544,599 and 6,105,520, the entireties of which are hereby incorporated herein by reference. Thus, the programmable border slitter 20 may be situated either in a separate cutting line or in-line with, and downstream of, a quilting machine.

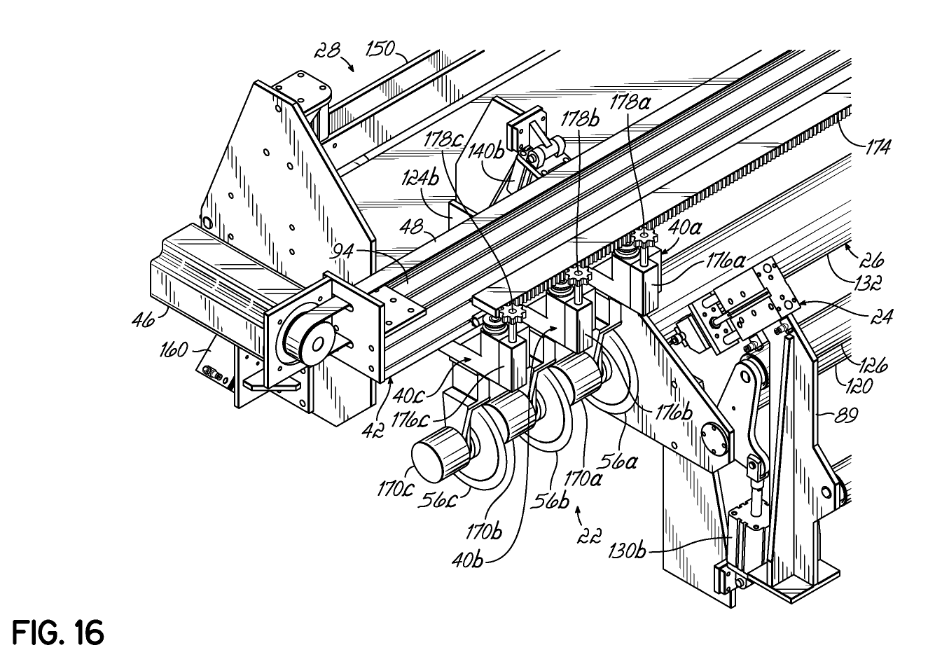

While the invention has been illustrated by the description of exemplary embodiments and while the exemplary embodiments have been described in considerable detail, there is no intention to restrict nor in any way limit the scope of the appended claims to such detail. Additional advantages and modifications will readily appear to those who are skilled in the art. For example, in the exemplary embodiment of FIG. 4, the slitting blades 56 are rotated by a slitting blade motor via a common shaft 52 that, in turn, is rotated by a belt drive 54. In alternative embodiments, the belt drive 54 may be replaced by a gear drive or clutch drive, for example, a mechanical, magnetic or fluid clutch. In further alternative embodiments, as shown in FIG. 16, each of the slitting blades, for example, slitting blades 56a, 56b, may be individually and directly rotated by respective slitting blade motors 170a, 170b. The slitting blade motors 170a, 170b are connected to, and controlled by, the control 180 as shown in phantom in FIG. 13.

In the exemplary embodiment of FIG. 3, a slitting blade positioning system 23 independent of the slitting blade assemblies 40 is operable to move each of the slitting blade assemblies 40 to desired positions along the length of the support bar assembly 42. Referring to FIG. 16, in an alternative embodiment, each of the slitting blade assemblies 40 may be individually moved along the support bar assembly 42 by respective slitting blade positioning systems. In this exemplary embodiment, a toothed rack 174 is mounted on support bar 94. Each of the slitting blade assemblies, for example, assemblies 40a, 40b, has a respective positioning motor, for example, positioning motors 176a, 176b that, in turn, rotate respective pinion gears 178a, 178b. The positioning motors 176a, 176b are connected to, and operated by, the control 180 as shown in phantom in FIG. 13. In this embodiment, multiple slitting blade assemblies 40 may be commanded by the control 180 to move individually and generally simultaneously along the support bar assembly 42.

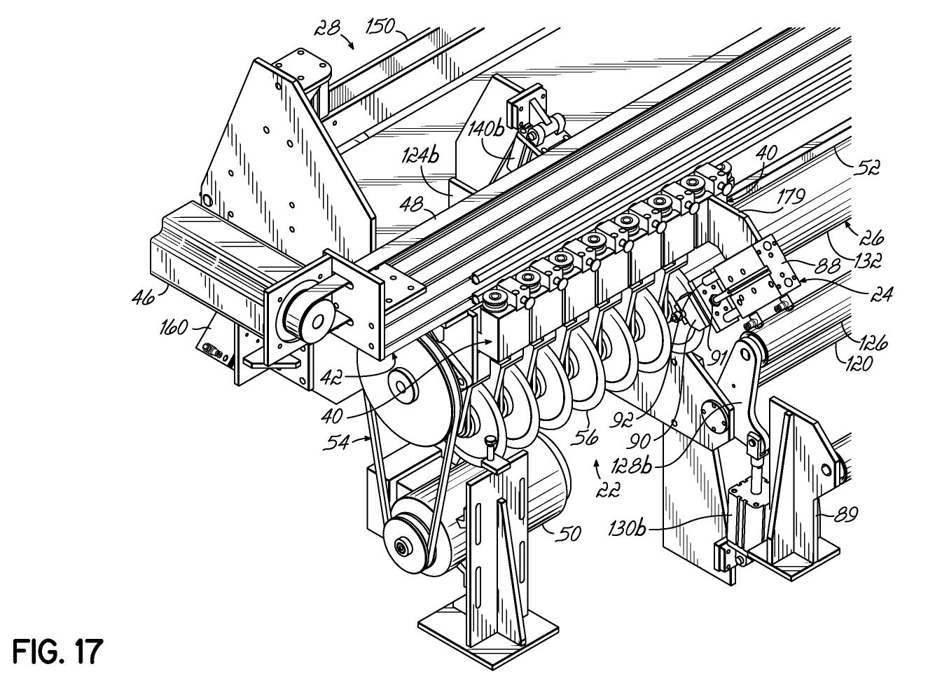

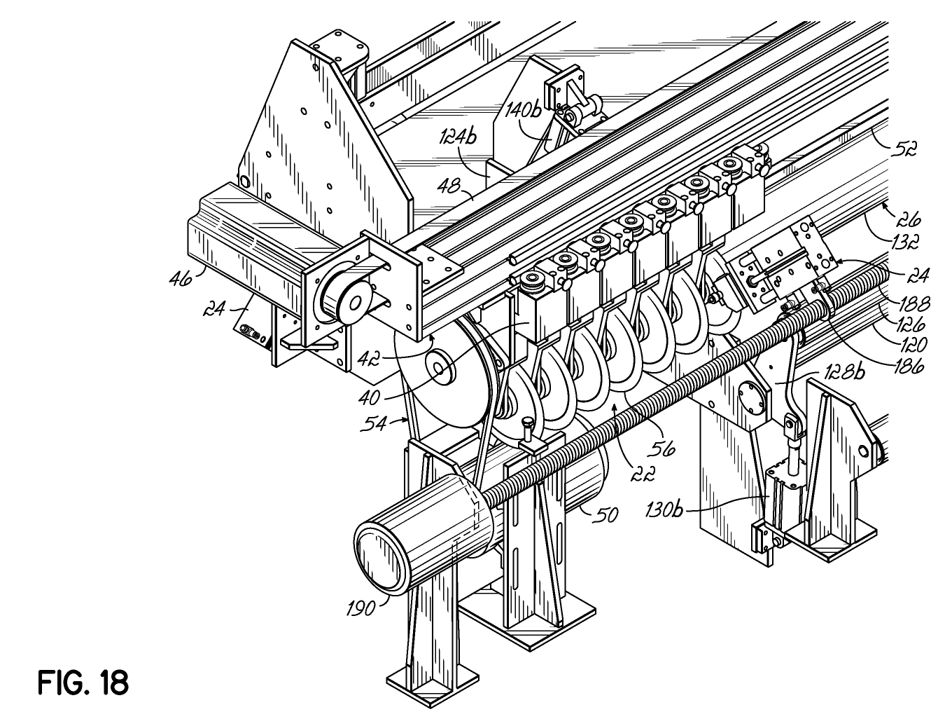

In the exemplary embodiment of FIG. 3, the sharpener assembly 24 is fixed to a bracket 89; and the slitting blades 56 are moved to the location of the sharpener 90. As shown in FIG. 17, in an alternative embodiment, a bracket 179 may be used to connect a sharpener 24 directly to a slitting blade assembly 40, so that the sharpener 24 moves with the slitting blade assembly 40. In this embodiment, each of the slitting blade assemblies 40 may be equipped with a respective sharpener 24, which is operable at any time by the control 180 to sharpen a respective slitting blade 56. In a further alternative embodiment shown in FIG. 18, the sharpener 24 may be connected to a threaded nut 186 that is mounted on a drive screw 188. The drive screw 188 is connected at one end to a sharpener drive motor 190 that, in turn, is connected to the control 180 as shown in phantom in FIG. 13. In this embodiment, the control 180 commands operation of the drive motor 190 to move the sharpener 24 adjacent a desired slitting blade 56 to be sharpened.

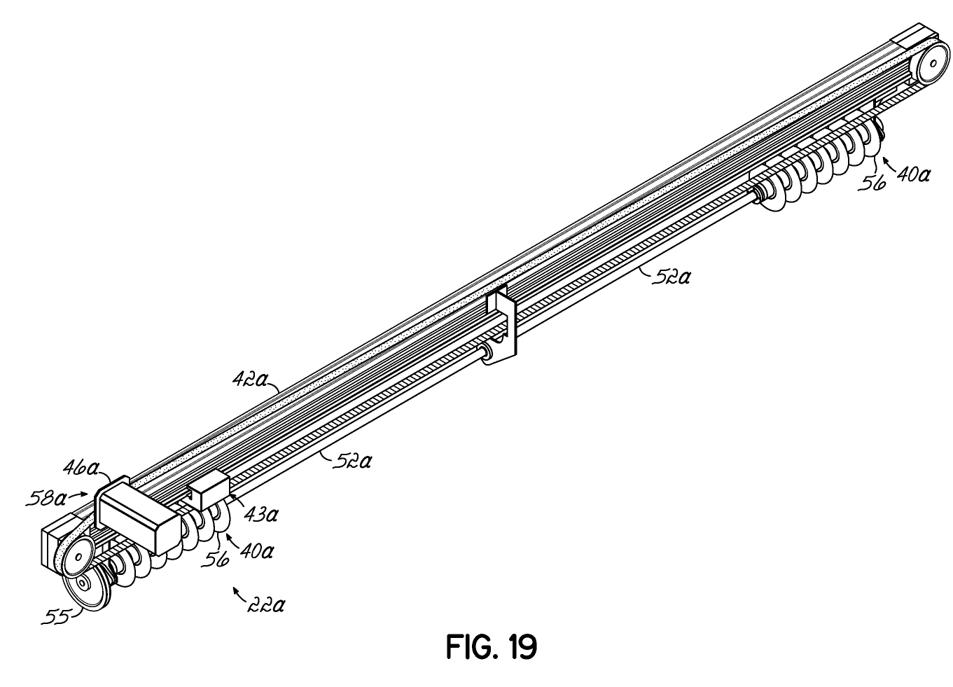

The first exemplary embodiment of a slitting system 22 with a slitting blade positioning system 23 mounted on a support bar assembly 42 is shown and described in FIGS. 1-8. In that embodiment, a slitting blade positioner 43 is moved along the support bar assembly 42 by a pulley and belt drive 54. The slitting blade positioner 43 is operative to engage a particular slitting blade assembly and move it to a desired position along a slitting blade drive shaft 52. Referring to FIG. 19, in an exemplary alternative embodiment, a second slitting blade system 22a includes a slitting blade positioner 43a that is slideably mounted on a support bar assembly 42a. The slitting blade positioner 43a is connected to a pulley and belt drive 58a that is driven by a positioning motor 46a in a manner similar to that previously described. An exemplary alternative embodiment of slitting blade assemblies 40a are mounted on a slitting blade drive shaft 52a and are moveable to different positions longitudinally on the drive shaft 52a by the slitting blade positioner 43a.

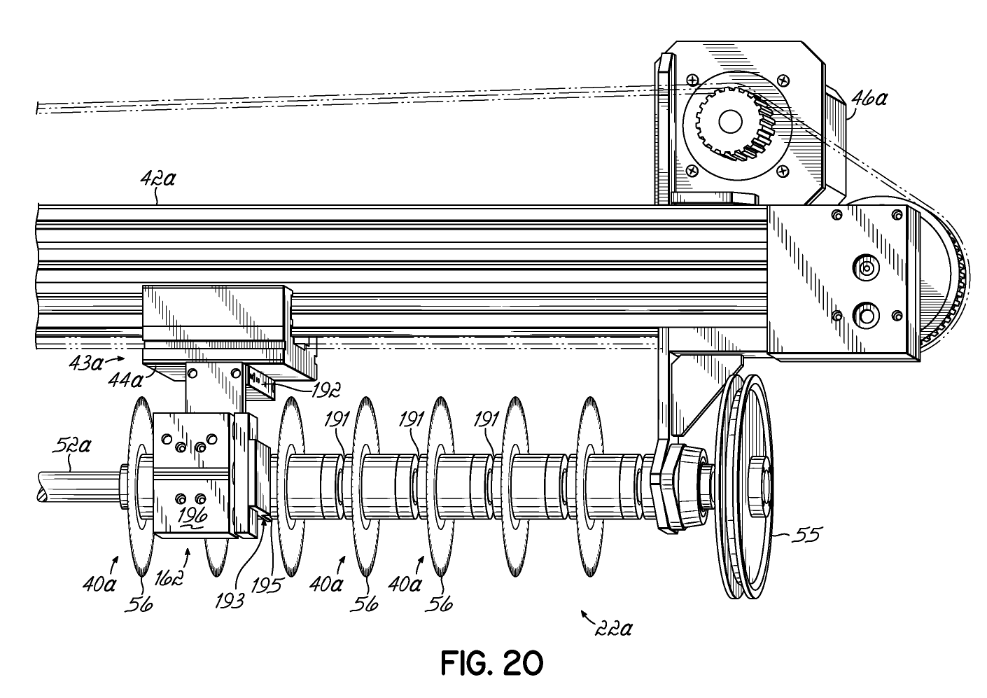

Referring to FIG. 20, the slitting blade positioner 43a includes a carriage 44a slideably mounted on the support bar assembly 42a. The carriage 44a supports a gripper 162 that is effective to engage each of the slitting blade assemblies 40a for movement along the drive shaft 52a. The slitting blade drive shaft 52a may have a circular or noncircular cross section.

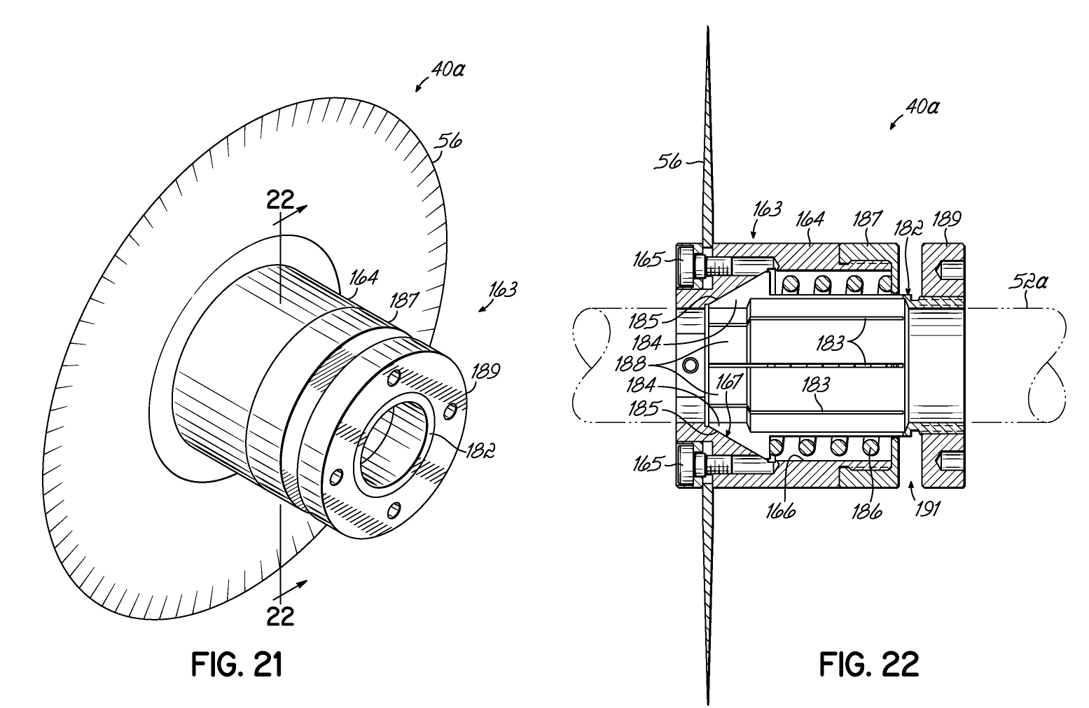

Referring to FIG. 21, each of the slitting blade assemblies 40a is comprised of a slitting blade 56 that is mounted to one end of a lock collar 163. As shown in FIG. 22, the slitting blade 56 is secured to a lock collar body 164 by threaded fasteners 165. The body 164 has an internal bore 166 that terminates at one end with an angled or tapered surface 167. A collet 182 is located in the bore 166. The collet 182 has longitudinally extending slits 183 that form a plurality of circumferentially spaced segments 188, which are movable in a radial direction. Flanges 184 extend from various ones of the segments 188 and have respective outer flared angled surfaces 185. The angled surfaces 185 are sized to contact against the tapered surface 167 of the body 164. The collet 182 has a center bore that is sized to receive the drive shaft 52a. A compression spring 186 is also located in the body bore 166 over the collet 182. A cap 187 is threaded onto an end of the collar body 164 and holds the compression spring 186 firmly against the flanges 184. The force of the compression spring 186 pushes the angled surfaces 185 against the tapered surface 167, which in turn, reacts a radial clamping force against segments 188 associated with respective flanges 184. Thus, the segments 188 are moved radially inward; and the collet 182 is pressed firmly against the drive shaft 52a with a force that prevents the cutting blade assembly 40a from rotating with respect to the drive shaft 52a.

A collet extension 189 is mounted by threaded engagement or a comparable connection to the collet 182 to form an annular space 191. Thus, if the collet extension 189 is moved to the right, as viewed in FIG. 22, the flanges 184 disengage from the tapered surface 167; and the segments 188 move radially outward a small amount. This radial expansion of the segments 188 releases the compressive clamping force the collet 182 was applying to the slitting blade drive shaft 52; and the slitting blade assembly 40a may be moved longitudinally along the drive shaft 52a, that is, to the right or left as viewed in FIG. 22.

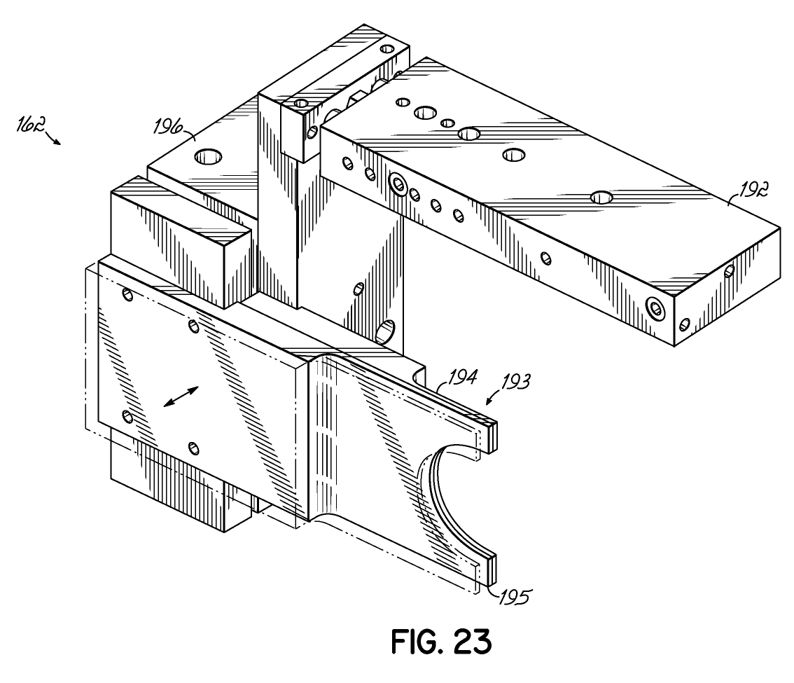

Referring to FIG. 23, the gripper 162 has a split fork 193 that extends toward the slitting blade drive shaft 52a. The split fork 193 has a first, inner fixed fork 194 that extends from the gripper 162 and a second, outer movable fork 195 that is connected to a cylinder 196. The gripper 162 further has a clearance cylinder 192 that is attached to the carriage 44a. Upon the control 180 providing a command that switches the state of the clearance cylinder 192, the split fork 193 is moved outward or to the left as viewed in FIG. 23 or toward a viewer in FIG. 20. At this outer position, the split fork 193 is clear of the slitting blades 56; and thus, the control 180 may command the positioning motor 46a to move the carriage 44a and gripper 162 to any desired location along the length of the drive shaft 52a. To relocate a slitting blade assembly 40a along the drive shaft 52a, the controller 180 commands the positioning motor 46a to move the griper 162 such that the fork 193 is aligned with a respective annular space 191.

The control 180 then commands the cylinder 192 to again switch states, which moves the split fork 193 inward to the right, as viewed in FIG. 23 and away from a viewer in FIG. 20, and the fork 193 is located in an annular space 191. Thereafter, the control 180 commands the cylinder 196 to switch states, which drives the movable fork 195 outward to a position shown in phantom in FIG. 23 and to the right as viewed in FIG. 20. Thus, the movable fork 195 moves the collet extension 189 and collet 182 to the right as viewed in FIGS. 20 and 22. This motion disengages the flanges 184 from the tapered surface 167 and releases the slitting blade assembly 40a from the drive shaft 52a. Thereafter, the control 180 may command the positioning motor 46a to move the carriage 44a, the gripper 162 and associated slitting wheel assembly 40a to any desired position along the drive shaft 52a.

When at a desired position, the control 180 commands the cylinder 196 to again switch states, which causes the movable fork 195 inward away from a viewer in FIG. 23 and to the left as viewed in FIG. 20. The compression spring 186 drives the flanges 184 against the tapered surface 167, which action radially deflects the flanges 184 and associated segments 188 inward toward the drive shaft 52a. The associated segments 188 again apply a clamping force on the drive shaft 52a to secure the slitting blade assembly 40a at the desired location on the drive shaft 52a. The control 180 then commands the cylinders 92 to switch states, which extends or moves the griper 162 and fixed fork 194 outward, that is, to the left as viewed in FIG. 23 and toward the viewer in FIG. 20. In that outer position, the split fork 193 clears the outer circumferences or edges of the slitting blades 56. The control 180 may then command the positioning motor 46a to move the carriage 44a and gripper 162 to any desired position along the drive shaft 52a.

In the embodiments shown in FIGS. 19-23, the slitting blades are not removable from the slitting blade assemblies 40a without removing the slitting blade assemblies from the drive shaft 52a. In an alternative embodiment, the slitting blade assemblies 40a may utilize the design shown in FIGS. 5 and 6, which permits the slitting blades 56a to be removed from the drive shaft 52a without removing the slitting blade assemblies 40a.

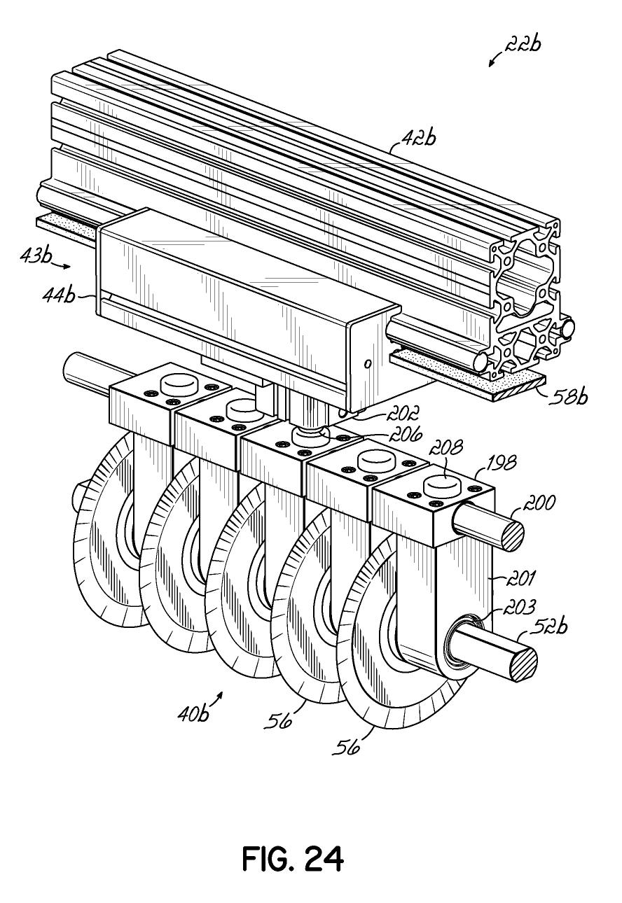

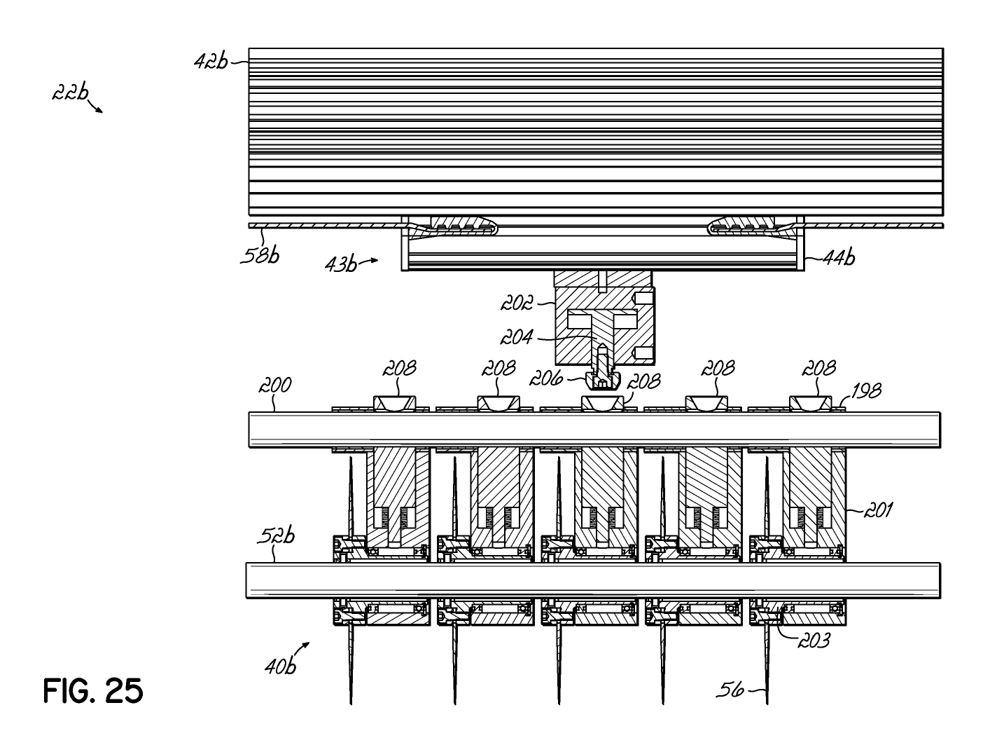

Referring to FIG. 24, in another exemplary alternative embodiment, a slitting blade system 22b includes a slitting blade positioner 43b that is slideably mounted on a support bar assembly 42b. The slitting blade positioner 43b is connected to a pulley and belt drive 58b that is driven by a positioning motor in a manner similar to that previously described with respect to positioning motor 46a of FIG. 19. Another exemplary alternative embodiment of slitting blade assemblies 40b are mounted for sliding motion on a slitting blade drive shaft 52b having a noncircular cross-sectional profile. Each slitting blade assembly 40b has a guide block 198 mounted for sliding motion on a guide shaft 200. Each guide block 198 has a respective mounting bracket 201 extending therefrom, and each mounting bracket has a bearing assembly 203 sized to slidingly receive a drive shaft 52. As shown in FIG. 25, the bearing assembly 203 permits a respective slitting blade assembly 40b to be moved to different positions longitudinally on the drive shaft 52b and guide shaft 200 by the slitting blade positioner 43b. The bearing assembly 203 further provides a respective slitting blade mount that permits the respective slitting blade to be mounted thereto and rotated by the drive shaft 52b.

Referring to FIGS. 24 and 25, the slitting blade positioner 43b includes a carriage 44b slideably mounted on the support bar assembly 42b. The carriage 44b supports a cylinder 202 that is effective to engage the slitting blade assemblies 40b for movement along the drive shaft 52b and guide shaft 200. The cylinder 202 has a piston 204 with a plunger 206 on its distal end. The plunger may be resiliently mounted on the distal end of the piston 204. The cylinder 202 is operable by the programmable control 180 of FIG. 13 to extend and retract the piston 204 and plunger 206. Each of the cutting blade assemblies has a receptacle 208 with a generally flared cross-sectional profile that is effective to receive a generally tapered cross-sectional profile of the plunger 206. Thus, the control 180 first moves the carriage 44b so that the plunger 206 is adjacent to a desired receptacle 208. The cylinder is then commanded to extend the piston 204, which inserts the plunger 206 into the adjacent receptacle 208. The control 180 is then operable to move the carriage 44b and one or more of the cutting blade assemblies 40b to a different longitudinal position with respect to the drive shaft 52b and guide shaft 200. The control 180 stops the carriage 44b and the one or more cutting blade assemblies 40b at the desired position and commands the cylinder 200 to change state and retract the piston 204 and plunger 206. Thus, the carriage 44b and cylinder 200 are operable to move each of the cutting blade assemblies to respective desired positions with respect to the cutting blade drive shaft 52b and guide shaft 200.

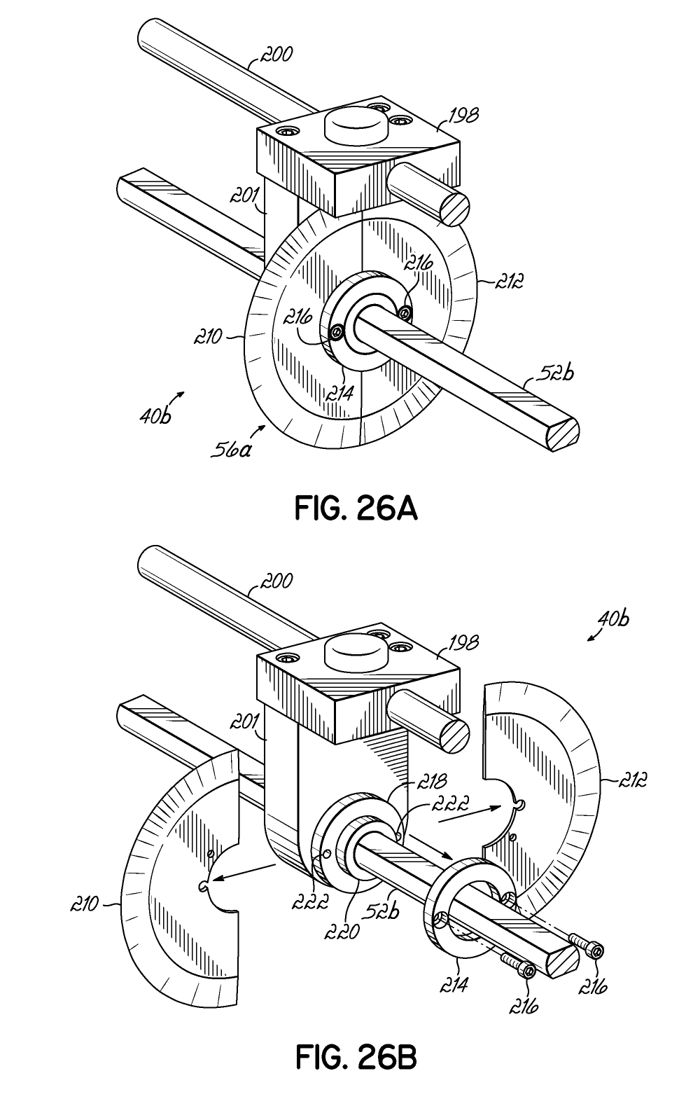

Referring to FIG. 26A, an exemplary alternative embodiment of a slitting blade 56a has two slitting blade halves 210, 212 that are secured in place by a locking collar 214 and fasteners 216. As shown in FIG. 26B, upon removing the fasteners 216, upon a slight sliding motion of the locking collar 214, the slitting blade halves may be removed. The removed position of the locking collar 214 is exaggerated in FIG. 26b for clarity. A blade mount 218 is part of a bearing assembly 203 within the mounting bracket 201 and shown FIG. 25. The blade mount 218 has a central hub 220 for locating the blade halves 210, 212 and locking collar 214. The blade mount 218 further has threaded holes for receiving the fasteners 216. The slitting blade 56a has an advantage of permitting a slitting blade to be removed from, and mounted on, the slitting blade assembly 40b, without having to remove the slitting blade assembly 40b from the drive shaft 52b. The slitting blade 56a may be used with any of the slitting blade assemblies described herein.

In the exemplary embodiments described above, the slitting blade positioning systems 23, 23a are mounted to respective support bar assemblies 42, 42a; however, in other embodiments, the slitting blade positioning assembly may be mounted to another guiding structure.

Therefore, the invention in its broadest aspects is not limited to the specific details shown and described. Consequently, departures may be made from the details described herein without departing from the spirit and scope of the claims which follow.

What is claimed is:

1. An apparatus for feeding and slitting soft goods comprising:
a plurality of rollers adapted to carry the soft goods, the plurality of rollers comprising a feed roller and a pinch roller;
a cross rail extending generally parallel to but spaced from the plurality of rollers;
a plurality of slitting blade assemblies movably mounted on the cross rail, the slitting blade assemblies comprising respective slitting blades;
a slitting blade motor operably connected to a slitting blade;
a slitting blade positioning system movable in a direction parallel with the cross rail, the slitting blade positioning system being operable to move a slitting blade assembly over a substantial length of the cross rail and thus, a substantial width of the soft goods;
a material feed motor connected to the feed roller and operable to move the soft goods past the slitting blade assembly;
a control connected to the slitting blade motor, the slitting blade positioning system and the material feed motor, the control operable to cause the slitting blade positioning system to move the slitting blade assembly to a desired position on the cross rail, and the control being further operable to turn on the slitting blade motor and the material feed motor, thereby moving the soft goods past the slitting blade.

2. The apparatus of claim 1 wherein the slitting blade is removable from the slitting blade assembly without removing the slitting blade assembly from the cross rail.

3. The apparatus of claim 1 wherein the cross rail comprises a length greater than a width of the soft goods, thereby permitting slitting blade assemblies to be moved to an end of the cross rail when not being used.

4. The apparatus of claim 1 further comprising a blade drive system connectable between the slitting blade motor and the slitting blade.

5. The apparatus of claim 4 wherein the blade drive system comprises a drive shaft rotatably mounted generally parallel with the cross rail and connected to the slitting blade motor.

6. The apparatus of claim 5 wherein the blade drive system comprises a belt drive system connected between the drive shaft and the slitting blade.

7. The apparatus of claim 1 further comprising a plurality of slitting blade motors, each slitting blade motor being operably connected to a different one of the slitting blade systems.

8. The apparatus of claim 1 the slitting blade positioning system is movably mounted on the cross rail.

9. The apparatus of claim 1 the one slitting blade assembly comprises a locking device for engaging and disengaging the cross rail.

10. The apparatus of claim 9 wherein the slitting blade positioning system is operable by the control to first, disengage the locking device, thereby permitting the slitting blade positioning system to move the one slitting blade assembly along the cross rail to the desired position and thereafter, engage the locking device to lock the one slitting blade assembly at the desired position.

11. The apparatus of claim 10 wherein the locking device comprises a shaft moveable into and out of contact with the cross rail.

12. The apparatus of claim 11 wherein the slitting blade positioning system comprises fingers moveable by the control to first lift the shaft out of contact with the cross rail and thereafter, release the shaft.

13. The apparatus of claim 12 wherein the locking device further comprises a biasing device to push the shaft into engagement with the cross rail upon being released by the fingers.

14. The apparatus of claim 10 wherein the locking device comprises a cylinder operable by the control to engage and disengage the cross rail.

15. The apparatus of claim 1 further comprising a blade sharpener mounted adjacent the respective slitting blade and operable by the control to sharpen the respective slitting blade.

16. The apparatus of claim 15 wherein the blade sharpener is fixedly mounted on the one slitting blade assembly.

17. The apparatus of claim 16 wherein the blade sharpener is fixedly mounted adjacent the one slitting blade assembly.

18. The apparatus of claim 16 further comprising a sharpening drive system for supporting the blade sharpener, the sharpening drive system operable by the control for moving the blade sharpener in a direction parallel to the cross rail to locations adjacent respective slitting blade assemblies.

19. The apparatus of claim 1 further comprising:
a feed roller for supporting the soft goods; and
a pinch roller mounted adjacent the feed roller and movable into and out of contact with the soft goods on the feed roller for moving the soft goods past the respective slitting blade.

20. The apparatus of claim 20 wherein the feed roller is connected to the feed motor.

21. The apparatus of claim 1 comprising a cross cutter system operably connected to the control for cutting the multiple pieces to a desired length.

22. An apparatus for feeding and slitting soft goods comprising:
a plurality of rollers adapted to carry the soft goods, the plurality of rollers comprising a feed roller and a pinch roller;
a cross rail extending generally parallel to, but spaced from, the plurality of rollers;
a guide shaft mounted generally parallel to, but spaced from, the cross rail;
a plurality of slitting blade assemblies mounted for sliding motion on the guide shaft, the slitting blade assemblies comprising respective slitting blades rotatable with respect to the slitting blade assemblies;
a slitting blade drive shaft mounted generally parallel to, but spaced from, the guide shaft, the slitting blade drive shaft operably connected to the slitting blades;
a slitting blade motor operable to rotate the slitting blade drive shaft and the slitting blades;
a slitting blade positioning system mounted on, and movable in a direction parallel with, the cross rail, the slitting blade positioning system being operable to move the slitting blade assemblies over a substantial length of the guide shaft and thus, a substantial width of the soft goods;
a material feed motor connected to the feed roller and operable to move the soft goods past the slitting blade assembly;
a control connected to the slitting blade motor, the slitting blade positioning system and the material feed motor, the control operable to cause the slitting blade positioning system to move the slitting blade assemblies to desired respective positions on the guide shaft, and the control being further operable to turn on the slitting blade motor and the material feed motor, thereby moving the soft goods past the slitting blades.

23. An apparatus for feeding and slitting soft goods comprising:
a plurality of rollers adapted to carry the soft goods, the plurality of rollers comprising a feed roller and a pinch roller;
a cross rail extending generally parallel to, but spaced from, the plurality of rollers;
a slitting blade drive motor;
a slitting blade drive shaft mounted generally parallel to, but spaced from, the guide shaft and rotatable by the slitting blade drive motor;
slitting blade assemblies movable in a direction generally parallel to the cross rail, the slitting blade assemblies comprising respective slitting blades mounted on the slitting blade drive shaft, and each of the slitting blades comprising a two slitting blade pieces permitting a respective slitting blade to be mounted on, and removed from, a respective slitting blade assembly without removing the respective slitting blade assembly from the slitting blade drive shaft;
a slitting blade positioning system mounted on, and movable in a direction parallel with, the cross rail, the slitting blade positioning system being operable to move the slitting blade assemblies over a substantial length of the guide shaft and thus, a substantial width of the soft goods;
a material feed motor connected to the feed roller and operable to move the soft goods past the slitting blade assembly;
a control connected to the slitting blade motor, the slitting blade positioning system and the material feed motor, the control operable to cause the slitting blade positioning system to move the slitting blade assemblies to desired respective positions on the guide shaft, and the control being further operable to turn on the slitting blade motor and the material feed motor, thereby moving the soft goods past the slitting blades.

24. A slitting blade for use with an apparatus for feeding and slitting soft goods, the slitting blade being mountable on a slitting blade assembly and being rotatable with respect to the slitting blade assembly by a slitting blade drive shaft extending through the slitting blade assembly, the slitting blade comprising:
a first slitting blade piece; and
a second slitting blade piece, the first slitting blade piece and the second slitting blade piece being mountable on the slitting blade assembly to form a rotatable slitting blade without removing the slitting blade assembly from the slitting blade drive shaft.
